(19) United States
(12) Patent Application Publication
(10) Pub. No.: US 2007/0080146 A1
(43) Pub. Date: Apr. 12, 2007

(54) Coloured laser marking

(76) Inventors: Werner Stockum, Reinheim (DE); Sylke Klein, Rossdorf (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/578,771

(22) PCT Filed: Oct. 14, 2004
(86) PCT No.: PCT/EP04/11583

§ 371 Date: May 9, 2006

(30) Foreign Application Priority Data
Nov. 10, 2003 (DE) 103 52 857.1
May 26, 2004 (DE) 10 2004 026 336.1

(51) Int. Cl. B23K 26/00; B42D 15/00; B32B 27/00

(52) U.S. Cl. 219/121.6; 283/117

(57) ABSTRACT

The invention relates to the colored laser marking and laser inscription of plastics based on welding of a polymer-containing inscription medium to the plastic surface.

The invention relates to the coloured laser marking and laser inscription of plastics based on welding of a polymer-containing inscription medium to the plastic surface.

With the aid of laser beams of various wavelength, it is possible permanently to mark and inscribe materials and products.

The marking and inscription are carried out through the action of laser energy
1. on the material itself (intrinsic reaction) or
2. on an inscription medium which is transferred from the outside to the material to be inscribed.

Thus, in marking method 1), metals, for example, react to laser irradiation with various tempering colours, woods become dark (carbonisation) at-the irradiated points and plastics, such as PVC, exhibit pale or dark discolorations (foaming, carbonisation) depending on the plastic colouring.

In plastics, these effects are frequently augmented or initiated by the addition of laser-sensitive pigments. The disadvantages generally consist in that only the “colours” white and black or various grey and bleach stages can be achieved, and that the laser-sensitive pigments have to be added to the entire plastic material in the masterbatch.

In marking method 2), if a laser beam of suitable energy and wavelength (for example IR laser) hits an inscription medium and if this is in contact with the material to be inscribed, the inscription medium is transferred to the material and fixed thereon. In this way, a coloured and black/white inscription or marking is possible. The amount of laser pigment actually required for the inscription here is significantly smaller than, for example, on masterbatch addition (inscription method 1).

Inscription media comprising glass frits or glass frit precursors with laser energy absorbers, to which—depending on the desired colour—inorganic and organic pigments, organometallic substances or metal powders are added, are generally known to the person skilled in the art. Processes of this type are described, for example, in WO 99/16625, U.S. 6,238,847 and WO 99/25562.

After application of these mixtures directly to the medium to be inscribed, for example by spraying, brushing, scattering, electrostatic charging, etc., or to support substrates, such as tapes or films, irradiation and marking with the requisite laser energy/density (cw laser (cw=continuous wave), 1-30 W or 100 W/cm²-5 MW/cm²) are carried out. In this way, it is possible to inscribe glass, ceramic, metal, stone, plastics and composites.

DE-A 10136479 A1 and DE-A 19942316 A1 describe mixtures of glass pigments and plastic granules which are laser-sensitive specifically for the coloured laser marking and inscription of plastics.

However, a common feature of the coloured plastic markings known from the prior art is that they still have excess, unfixed colorant on the plastic surface after the laser inscription process, which often results in smeared, unsharp markings/inscriptions (powder traces), which can also bleed out or effloresce or flake off later.

This makes time-consuming and cost-incurring post-cleaning and drying steps necessary, which is particularly undesired or unacceptable for an inline production process with product inscription as the final process step. Furthermore, the coloured marking or inscription fades on use under the corresponding environmental influences, etc.

The object of the present invention was therefore to find a process which, under the action of laser light, results in an absolutely colour-fast, permanent and abrasion-resistant laser marking and inscription of plastics.

Surprisingly, it has now been found that plastics can be inscribed in colour if a polymer-containing inscription medium is welded to the plastic surface under the action of laser light. The plastic to be inscribed must not itself comprise any substances which absorb laser light. The technical solution comprises separating the energy absorber in a defined manner from the actual colouring inscription medium.

The invention therefore relates to a process for the permanent and abrasion-resistant coloured inscription or marking of plastics, which is distinguished by the fact that use is made of a layer system which consists of two layers lying one on top of the other and separated by a support film, where the first layer consists of a plastic which comprises an energy absorber intrinsically or as a layer, and the second layer applied to a support film serves as inscription medium and comprises a colorant and a polymer component, where the polymer component is welded to the plastic surface under the action of laser light during the inscription/marking.

The term “coloured laser marking and inscription” is taken to mean marking and inscription of a plastic using all colours and non-colours, including black, white and all grey shades.

In the process according to the invention,
any smearing and/or later bleeding/efflorescence/flaking-off of the colorant is prevented,
undesired cleaning steps after the actual marking and inscription process are saved,
the colour fastness of the marking and inscription during later use is guaranteed,
the use of all organic and inorganic colorants is possible.

Compared with the prior art, the laser energy in the present invention is not used for sublimation of the colorants or melting of glass pigments, but instead for welding of the polymer component in the inscription medium to the plastic surface. Colour-fast marking and inscription is achieved by homogeneously warming a polymer-containing inscription medium and at the same time avoiding local thermal overheating.

In the process according to the invention, the polymer component in the inscription medium is softened or melted by means of laser energy. The polymer component dissolves together with the colorants of the inscription medium and is then durably welded to the plastic surface.

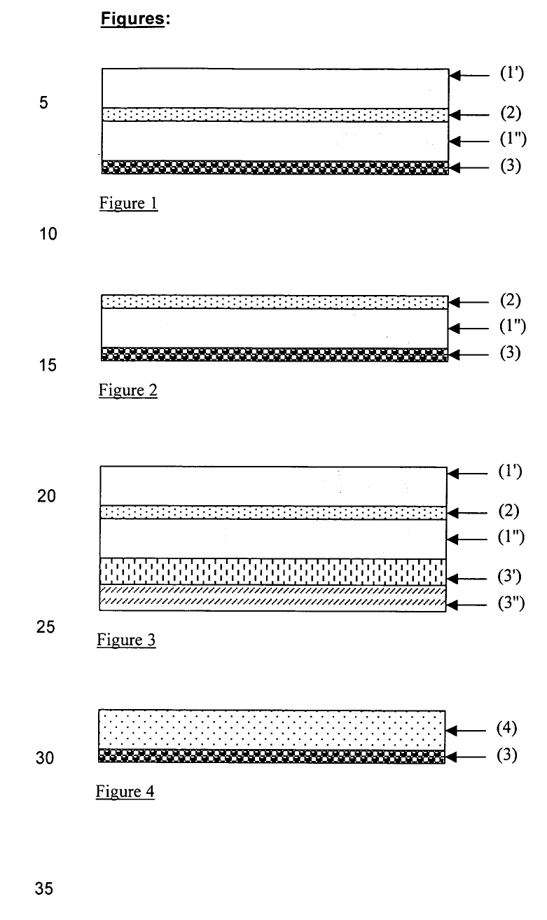

In particular, layer systems as depicted in FIGS. 1-4 have proven particularly suitable here. FIG. 1 shows a plastic layer consisting of support layers (1′) and (1″) which are transparent and stable to laser light and which have a laser-sensitive energy-absorber layer (2) as interlayer. Layers (1′), (1″) and (2) are bonded to one another as a unit. The polymer-containing inscription medium (3) is applied to this support-layer system as a layer, for example in the form of a paste (with or without support). The support layer (1″) and layer (3) are strongly bonded to one another, for example by welding, adhesive bonding, lamination, etc.

FIG. 2 shows, as a further variant, the layer structure from FIG. 1, but without the support layer (1′).

FIG. 3 shows, in contrast to FIGS. 1 and 2, that the inscription medium can likewise be composed of two layers (3′, 3″), where the polymer component is applied to layer (1″) as an extra layer (3′), and the colorant layer (3″) is applied to layer (3′).

FIG. 4 shows a compressed layer structure having a support layer (4) which is already doped with energy absorber and which is coated with the polymer-containing inscription medium (3).

Layer (3) with the inscription medium is laid on the plastic to be inscribed and brought into close contact with the areas to be marked by means of the requisite contact pressure or suitable adhesives (permanent or pressure/heat-activable). The inscription or marking is then carried out using a suitable laser, preferably by the beam deflection or mask method.

Suitable materials for the support layers (1′, 1″) are all plastics which are ideally transparent and/or translucent to the laser light in the stated wave-length range and which are not damaged or destroyed by the interaction with the laser light. If the support-layer system (1) is composed of two or more layers (1′, 1″), these layers may be identical or different.

Suitable plastics are preferably thermoplastics. In particular, the plastics consist of polyesters, polycarbonates, polyimides, polyacetals, polyethylene, polypropylene, polyamides, polyester-ester, polyether-ester, polyphenylene ether, polyacetal, polybutylene terephthalate, polymethyl methacrylate, polyvinylacetal, polyvinyl chloride, polystyrene, acrylonitrile-butadiene-styrene (ABS), acrylonitrile-styrene-acrylate (ASA), polyether-sulfones and polyether-ketones, and copolymers and/or mixtures thereof.

Of the plastics mentioned, particular preference is given to polyesters, polycarbonates and polyimides.

Especially suitable for the inscription and marking of three-dimensional plastic parts or surfaces are unstretched amorphous plastic support films made from polyethylene terephthalate, polyester and polyamide.

The plastic supports are preferably employed in the form of films, strips or sheets and preferably have layer thicknesses of 2-100 μm. The maximum layer thickness of the support-layer system (1) is 250 μm, irrespective of whether it consists of a support layer or of a plurality of support layers (1′, 1″, etc.).

The support-layer system comprises an energy absorber in amounts of 0.01-20% by weight, preferably 0.05-15% by weight, in particular 0.1-10% by weight.

The energy absorber here can be uniformly distributed in the support layer, as depicted in FIG. 4, or applied to (1″) as a layer (FIG. 2) or included between two or more plastic support layers (1′, 1″) (FIG. 1). In the latter case, the energy absorber is stirred into a binder and/or adhesive and applied to a plastic support layer (1′), for example by brushing, spraying, printing, rolling, knife coating, and a second plastic support layer is subsequently applied, for example by lamination or hot lamination.

If the absorber layer is located on layer (1″) or between two layers (1′, 1″), it has a thickness of 50 nm-100 μm, preferably 100 nm-50 μm and in particular 150 nm-10 μm.

Suitable binders or adhesives for the energy absorber layer are, for example, cellulose nitrate, cellulose acetate, hydrolysed/acetylated polyvinyl alcohols, polyvinylpyrrolidones, polyvinylbutyrals, polyacrylates, and also copolymers of ethylene/ethylene acrylate, epoxy resins, polyesters, polyisobutylene, polyamides or mixtures thereof. The binder or adhesive enables homogeneous application of the energy absorber to the plastic support-layer system (1).

Energy absorbers which can be used are all materials which absorb the laser light energy to an adequate extent in the stated wavelength range and convert it into thermal energy.

Suitable energy absorbers for the marking are preferably based on carbon, metal oxides, such as, for example, Sn(Sb)O_{2,} TiO_{2,} carbon black, anthracene, IR-absorbent colorants, such as, for example, perylenes/ rylenes, pentaerythritol, copper hydroxide phosphates, molybdenum disulfides, antimony(III) oxide and bismuth oxychloride, flake-form, in particular transparent or semitransparent substrates comprising, for example, phyllosilicates, such as, for example, synthetic or natural mica, talc, kaolin, glass flakes, SiO₂ flakes or synthetic support-free flakes. Also suitable are flake-form metal oxides, such as, for example, flake-form iron oxide, aluminium oxide, titanium dioxide, silicon dioxide, LCPs (liquid crystal polymers), holographic pigments, conductive pigments or coated graphite flakes.

Flake-form pigments which can be employed are also metal powders, which may be uncoated or also covered with one or more metal-oxide layers; preference is given, for example, to Al, Cu, Cr, Fe, Au, Ag and steel flakes. If corrosion-susceptible metal flakes, such as, for example, Al, Fe or steel flakes, are to be employed in uncoated form, they are preferably coated with a protective polymer layer.

Besides flake-form substrates, it is also possible to employ spherical pigments, for example comprising Al, Cu, Cr, Fe, Au, Ag and/or Fe.

Particularly preferred substrates are mica flakes coated with one or more metal oxides. The metal oxides used here are both colourless, high-refractive-index metal oxides, such as, in particular, titanium dioxide, antimony(III) oxide, zinc oxide, tin oxide and/or zirconium dioxide, and coloured metal oxides, such as, for example, chromium oxide, nickel oxide, copper oxide, cobalt oxide and in particular iron oxide (Fe₂O_{3,} Fe₃O₄). The energy absorber used is particularly preferably antimony(III) oxide, alone or in combination with tin oxide.

These substrates are known and in the majority of cases are commercially available, for example under the trade name Iriodin® Lazerflair from Merck KGaA, and/or can be prepared by standard processes known to the person skilled in the art. Pigments based on transparent or semitransparent flake-form substrates are described, for example, in the German Patents and Patent Applications 14 67 468, 19 59 998, 20 09 566, 22 14 454, 22 15 191, 22 44 298, 23 13 331, 25 22 572, 31 37 808, 31 37 809, 31 51 343, 31 51 354, 31 51 355, 32 11 602, 32 35 017, 38 42 330 and 44 41 223.

Coated SiO₂ flakes are disclosed, for example, in WO 93/08237 (wet-chemical coating) and DE-A 196 14 637 (CVD process).

Multilayered pigments based on phyllosilicates are disclosed, for example, in DE-A 196 18 569, DE-A 196 38 708, DE-A 197 07 806 and DE-A 198 03 550. Particularly suitable are multilayered pigments which have the following structure:
mica +TiO₂+SiO₂+TiO₂
mica +TiO₂+SiO₂+TiO₂/Fe₂O₃
mica +TiO₂+SiO₂+(Sn, Sb)O₂
SiO₂ flake +TiO₂+SiO₂+TiO₂

Particularly preferred laser light-absorbent substances are anthracene, perylenes/rylenes, such as, for example, ter- and quaterrylenetetra-carboxydiimides, pentaerythritol, copper hydroxide phosphates, molybdenum disulfide, antimony(lll) oxide, bismuth oxychloride, carbon, antimony, Sn(Sb)O₂, TiO₂, silicates, SiO₂ flakes, metal oxide-coated mica and/or SiO₂ flakes, conductive pigments, sulfides, phosphates, BiOCl, or mixtures thereof.

The energy absorber can also be a mixture of two or more components.

The inscription medium can be applied to the support system as a paste or as a layer with support (FIG. 1 or 4). The inscription medium essentially consists of a binder, colorants, polymer component and optionally additives.

Both organic and inorganic colorants are suitable for the inscription. Suitable colorants are all those known to the person skilled in the art which do not decompose during the laser irradiation and are photostable. The colorant can also be a mixture of two or more substances. The proportion of colorants in the inscription medium is preferably 0.1-30% by weight, in particular 0.2-20% by weight and very particularly preferably 0.5-10% by weight, based on the polymer component fraction.

Suitable colorants are all organic and inorganic dyes and pigments known to the person skilled in the art. Particularly suitable are azo pigments and dyes, such as, for example, mono- and diazo pigments and dyes, polycyclic pigments and dyes, such as, for example, perinones, perylenes, anthraquinones, flavanthrones, isoindolinones, pyranthrones, anthrapyrimidines, quinacridones, thioindigo, dioxazines, indanthronones, diketo-pyrrolo-pyrroles, quinophthalones, metal-complexing pigments and dyes, such as, for example, phthalocyanines, azo, azomethine, dioxime and isoindolinone complexes, metal pigments, oxide and oxide hydroxide pigments, oxide mixed-phase pigments, metal-salt pigments, such as, for example, chromate and chromate-molybdate mixed-phase pigments, carbonate pigments, sulfide and sulfide-selenium pigments, complex-salt pigments and silicate pigments.

Of the said colorants, particular preference is given to copper phthalocyanines, dioxazines, anthraquinones, monoazo- and diazo pigments, diketo-pyrrolo-pyrrole, polycyclic pigments, anthrapyrimidines, quinacridones, quinophthalones, perinones, perylene, acridines, azo dyes, phthalocyanines, xanthenes, phenazines, coloured oxide and oxide hydroxide pigments, oxide mixed-phase pigments, sulfide and sulfide-selenium pigments, carbonate pigments, chromate and chromate-molybdate mixed-phase pigments, complex-salt pigments and silicate pigments.

The polymer component in the inscription medium is an essential constituent of the medium and can consist, for example, of low-melting polymers, such as, for example, polyesters, polycarbonates, polyolefins, polystyrene, polyimides, polyamides, polyacetals and copolymers of the said polymers, and terpolymers of vinyl chloride, dicarboxylates and vinyl acetate or hydroxyl/methyl acrylate, or mixtures thereof. The polymer component can be dissolved in the inscription medium and/or can be in undissolved form as a fine powder. The particle sizes are preferably 10 nm- 100 μm, in particular 100 nm-50 μm and very particularly preferably 500 nm- 15 μm.

It is also possible to employ a mixture of different polymer components or particles, where both the particle sizes and the chemical composition can differ.

It is optionally also possible to add inorganic finely divided powders, such as highly disperse silicic acid or titanium oxide, in order to guarantee precise dissolution of the inscription or marking out of the inscription medium (here out of the polymer matrix).

The inscription medium preferably comprises 20-90% by weight, in particular 40-60% by weight and very particularly preferably 40-90% by weight, of polymer component, based on the total weight of polymer component+colorant+binder.

The polymer component/colorant ratio is preferably 80:1-1:1, in particular 50:1-2:1, very particularly preferably 20:1-5:1.

The polymer component/energy absorber ratio is preferably 70:1-1:1, in particular 40:1-2:1, very particularly preferably 20:1-3:1.

As further component, the inscription medium comprises a binder. The binder enables homogeneous application of the inscription layer (3) to the support layer (1) or to a support, such as, for example, glass or plastic.

All binders known to the person skilled in the art are suitable, in particular cellulose, cellulose derivatives, such as, for example, cellulose nitrate, cellulose acetate, hydrolysed/acetalated polyvinyl alcohols, polyvinyl-pyrrolidones, polyacrylates, and also copolymers of ethylene/ethylene acrylate, polyvinylbutyrals, epoxy resins, polyesters, polyisobutylene and polyamides.

Depending on the type of plastic, all lasers known to the person skilled in the art can be employed for the inscription/marking. The laser parameters are dependent on the particular application and can easily be determined by the person skilled in the art.

The inscription with the laser is carried out by introducing the test specimen into the ray path of a pulsed laser, preferably a CO₂ or Nd:YAG or Nd:YVO₄ laser. Furthermore, inscription with an excimer laser, for example via a mask method, is possible. However, the desired results can also be achieved using other conventional types of laser which have a wavelength in the region of high absorption of the laser light-absorbent substance used. The marking obtained is determined by the irradiation time (or number of pulses in the case of pulsed lasers) and irradiation power of the laser (pulse power density in the case of pulsed lasers) and the plastic system or coating system used. The power of the lasers used depends on the particular application and can readily be determined in each individual case by the person skilled in the art.

The laser used generally has a wavelength in the range from 157 nm to 10.6 μm, preferably in the range from 532 nm to 10.6 μm. Mention may be made here by way of example of CO₂ lasers (10.6 μm) and Nd:YAG and Nd:YVO₄ lasers (1064 and 532 nm respectively) or pulsed UV lasers. The excimer lasers have the following wavelengths: F₂ excimer laser (157 nm), ArF excimer laser (193 nm), KrCl excimer laser (222 nm), KrF excimer laser (248 nm), XeCl excimer laser (308 nm), XeF excimer laser (351 nm), frequency-multiplied Nd:YAG lasers having wavelengths of 355 nm (frequency-tripled) or 265 nm (frequency-quadrupled). Particular preference is given to the use of Nd:YAG and YVO₄ lasers (1064 and 532 nm respectively) and CO₂ lasers.

On use of pulsed lasers, the pulse frequency is generally in the range from 1 to 100 kHz. Corresponding lasers which can be employed in the process according to the invention are commercially available.

Preference is given to the use of a YAG laser, YVO₄ laser or CO₂ laser in various laser wavelengths, 1064 nm or 808-980 nm. The labelling is possible both in cw and in pulsed operation. The suitable power spectrum of the inscription laser covers from 2 to 300 watts, and the pulse frequency is in the range from 1 to 200 kHz.

The plastic inscriptions according to the invention can be used in all cases where plastics have hitherto been marked or inscribed using printing, embossing or engraving processes or in all cases where no colour-fast and permanent inscription/marking or no inscription/marking at all or only inscription/marking using laser-sensitive pigments in the plastic itself was hitherto possible. The advantages of the labelling type according to the invention are colour fastness, permanence and flexibility/individuality, i.e. the labelling is carried out without a mask, klischee or stamp specification.

It is possible to mark and inscribe plastics of any type and shape, for example
in the packaging industry (batch number, use-by dates, notes)
in the security sector (forgery-proof coding and labelling)
in the motor vehicle and aircraft industry (cables, plugs, switches, containers, functional parts, tubes, lids, handles, levers, etc.)
in medical technology (equipment, instruments, implants)
in agriculture (animal marking)
in electrical engineering/electronics (cables, plugs, switches, functional parts, type plates, rating plates)
in the decorative sector (logos, model designation for equipment of all. types, containers, toys, tools, individual markings).

The invention also relates to plastics which have been marked or inscribed in colour by the process according to the invention.

The following examples are intended to explain the invention, but without limiting it.

### WORKING EXAMPLES

### Example 1

Production of an Energy Absorber Layer (2)

18.5 g of ethyl acetate
1.5 g of PVB (polyvinylbutyral, Pioloform®, Wacker-Chemie)
3-5 g of Sn(Sb)O₂(d₅₀ value<1.1 μm) (Du Pont)

Polyvinylbutyral is dissolved in the initially introduced solvent ethyl acetate and stirred well. The energy absorber Sn(Sb)O₂ is subsequently stirred in, and a homogeneous paste is prepared. The amount of energy absorber is dependent on the energy absorption of the colorant and should be set thereto.

The paste is applied to a polyester film having a thickness of 5-250 μm, preferably 23 μm, using a 30 μm hand coater and dried.

The hot lamination can be carried out, for example, using a PE (polyethylene)-coated polypropylene film (Waloten® film from Pütz) at about 140° C.

### Example 2

Production of an Energy Absorber Layer (2)

18.5 g of ethyl acetate
1.5 g of PVB (polyvinylbutyral, Pioloform®, Wacker-Chemie)
2.0 g of gas black (d₅₀ value<17 nm) (Special Black 6 from Degussa)

The processing is carried out as in Working Example 1. The absorber employed is gas black.

The paste is applied to polyester films having a thickness of 5-250 μm using a 90 μm hand coater and dried. A further polyester film or polypropylene film can be applied to the absorber layer by hot lamination (as described in Working Example 1).

### Example 3

Production of an Energy Absorber Layer (2)

20 g of Masterblend 50 (SICPA-AARBERG AG)
1 g of Iriodin® Lazerflair 825 (particle size<20 μm) (Merck KGaA)
10 g of ethyl acetate/ethanol (1:1)

The absorber Iriodin® Lazerflair 825 is incorporated into the Masterblend 50 under gentle conditions and printed by gravure printing onto a polyester film having a thickness of 5-250 μm, preferably 23 μm. The desired viscosity can be set using the solvent mixture ethyl acetate/ethanol. The application rate is 0.5-1 g/cm².

### Example 4

Production of a Support Layer with Energy Absorber

The support layer is produced from polyester already containing energy absorber by addition of 300 g of Sn(Sb)O₂ having a particle size of <1 μm (Du Pont) to the polyester masterbatch (10 kg). Films having a layer thickness of 5-200 μm are subsequently produced. The finished film contains 0.05-10% by weight of energy absorber, depending on the layer thickness.

### Example 5

Preparation of a Polymer-Containing Inscription Medium (3)

20 g of ethyl acetate
2 g of nitrocellulose
6 g of polypropylene powder (d₅₀<50 μm) (for example Coathylene PB 0580, Du Pont)
0.2 g of Cu phthalocyanine

The nitrocellulose is dissolved in the initially introduced solvent ethyl acetate and stirred well. The polypropylene powder and the colorant copper phthalocyanine are subsequently stirred in, and a homogeneous paste is prepared.

The paste is applied to polyester films having a thickness of 5-250 μm using a 90 μm hand coater and dried.

### Example 6

Preparation of a Polymer-Containing Inscription Medium (3)

20 g of ethyl acetate
2 g of nitrocellulose
6 g of polypropylene powder (d₅₀<50 μm) (for example Coathylene PB 0580, Du Pont)
0.2 g of titanium oxide

The processing is carried out analogously to Example 5. The colorant employed is titanium oxide.

The paste is applied to polyester films having a thickness of 5-250 μm using a 90 μm hand coater and dried.

### Example 7

Preparation of a Polymer-Containing Inscription Medium (3)

40 g of butyl acetate
12 g of polypropylene powder (d₅₀<50 μm)
4 g of nitrocellulose
0.6 g of pigment-grade carbon black (FW 200, d₅₀13 μm, Degussa)

The processing is carried out analogously to Example 5. The colorant employed is pigment-grade carbon black.

The paste is applied to polyester films having a thickness of 5-250 μm in a layer thickness of 225 μm and dried.

### Example 8

Preparation of a Polymer-Containing Inscription Medium (3)

40 g of MEK (methyl ethyl ketone)
22 g of toluene
8.5 g of PVC (T_{g}:40-89° C.)
2.5 g of ethylene-vinyl acetate terpolymer
20 g of colorant
6 g of highly disperse silicic acid

The processing is carried out analogously to Example 5. The colorant employed is, for example, titanium oxide (Kronos 2220, 2222, 2063S, 2090, 2310, Kronos International, Inc.) or Irgazin DPP Red (Ciba Geigy) or Sandoplast Blue (Clariant).

### Example 9

Preparation of a Polymer-Containing Inscription Medium (3)

30 g of MEK (methyl ethyl ketone)
30 g of butyl acetate
25 g of cyclohexanone
10 g of PVC/PVA copolymer (85/15)
5 g of PVB (polyvinylbutyral)
10 g of colorant

The processing is carried out analogously to Example 5. The colorant employed is, for example, pigment-grade carbon black (FW-2 from Degussa, d₅₀ 13 μm).

### Example 10

Production of a Multilayer Inscription Band

The support film—energy absorber layer (Examples 1-4) is placed together with the support film—inscription medium (Examples 5-9) and laminated together with the aid of a hot laminator (Erichson model 647). The heatable roll is set here to a temperature of 140-175° C. After the hot lamination, the two films are strongly bonded to one another. If a PE-coated polypropylene film (Waloten® film from Pütz) as in Example 1 is used, the lamination can be carried out at about 140° C.

### Example 11

Production of a Multilayer Inscription Band

The inscription medium (Examples 5-9) is applied to the support film-energy absorber layer (Examples 1-4) in a layer thickness of 225 μm and dried.

### Example 12

Production of a Multilayer Inscription Band

A polymer-containing inscription medium is applied to the inscription side of a PET film (thickness: 5, 12, 15, 19, 23, 25, 36, 50 μm) as shown in FIG. 2 in a layer thickness of 0.5-1.5 μm, and an energy absorber layer is printed onto the laser side in a layer thickness of 0.7-1.5 μm.

### Example 13

Marking Experiments and Results

The support-layer systems with the absorber layer and the inscription medium (FIGS. 1-4) are employed for the permanent marking and inscription of plastics with the aid of the following laser types:

a) Nd: YAG (cw mode)

| | |
|---|---|
| 12 watt laser | Trumpf laser |
| Nd: | YAG (1064 and 532 nm) |
| Laser intensity: | 10-90%, cw mode |
| Speed: | 100-1500 mm/s |

b) Nd: YVO₄ laser (cw mode, pulsed)

| | |
|---|---|
| 16 watt laser | Rofin Sinar |
| Nd: | YVO₄ (1064 nm) |
| Laser intensity: | 20-90%, cw mode, pulsed |
| Pulse frequency: | 10-100 kHz |
| Speed: | 400-2000 mm/s |

c) Nd: YAG laser (pulsed)

| | |
|---|---|
| 60 watt laser | Baasel |
| Nd: | YAG (1064 nm) |

Lamp current 16 A, pulsed mode

| | |
|---|---|
| Pulse frequency: | 20,000 Hz |
| Speed: | 200 mm/s |
| Wobbler frequency: | 16 Hz |
| Pulse duration: | 0.05 ms |

Compared with the markings in cw mode, the coloured inscriptions and markings in pulsed mode are distinguished by
greater edge sharpness
smoother surface at the marked points.

1. Process for the permanent and abrasion-resistant coloured inscription or marking of plastics, characterised in that use is made of a layer system which consists of two layers lying one on top of the other and separated by a support film, where the first layer consists of a plastic which comprises an energy absorber intrinsically or as a layer, and the second layer applied to a support film serves as inscription medium and comprises a colorant and a polymer component, where the polymer component is welded to the plastic surface under the action of laser light during the inscription/marking.

2. Process according to claim 1, characterised in that the first layer is composed of one or more support layers, and the energy absorber is located on or between these support layers.

3. Process according to claim 1, characterised in that the energy absorber is selected from the group consisting of carbon, metal oxides, silicates, SiO₂ flakes, metal oxide-coated mica and/or SiO₂ flakes, conductive pigments, sulfides, phosphates, BiOCl, anthracene, perylenes, rylenes, pentaerythritol, or mixtures thereof.

4. Process according to claim 1, characterised in that the plastic layer comprises 0.01-20% by weight of energy absorber.

5. Process according to claim 1, characterised in that the inscription medium essentially consists of a binder, colorants, polymer component and optionally additives.

6. Process according to claim 5, characterised in that the binder is selected from the group consisting of cellulose, cellulose derivatives, polyvinyl alcohols, polyvinylpyrrolidones, polyacrylates, polymethacrylates, epoxy resins, polyesters, polyethers, polyisobutylene, polyamide, polyvinylbutyrals and mixtures thereof.

7. Process according to claim 1, characterised in that the inscription medium comprises the polymer component in dissolved and/or particulate form in amounts of 30-90% by weight.

8. Process according to claim 1, characterised in that the polymer component in particulate form has particle sizes of 10 nm-100 μm.

9. Process according to claim 1, characterised in that the polymer component consists of polyesters, polycarbonates, polyolefms, polystyrene, polyimides, polyamides, polyacetals and copolymers of the said polymers, and terpolymers of vinyl chloride, dicarboxylates and vinyl acetate or hydroxyl/methyl acrylate or mixtures thereof.

10. Process according to claim 1, characterised in that the inscription medium comprises organic and/or inorganic colorants.

11. Process according to claim 1, characterised in that the inscription medium comprises 0.1-30% by weight of colorants, based on the polymer component fraction.

12. Plastics which have been laser-marked or laser-inscribed by the process according to claim 1.
